(19) United States
(12) Patent Application Publication
(10) Pub. No.: US 2018/0286525 A1
(43) Pub. Date: Oct. 4, 2018

(54) CONTROL OF CORROSION BY MOLTEN SALTS

(71) Applicant: Ian Richard SCOTT, Warwickshire (GB)

(72) Inventor: Ian Richard SCOTT, Warwickshire (GB)

(21) Appl. No.: 15/764,769

(22) PCT Filed: Dec. 8, 2016
(86) PCT No.: PCT/GB2016/053861

§ 371 Date: Mar. 29, 2018

(30) Foreign Application Priority Data
Oct. 8, 2015 (GB) 1517835.3

(51) Int. Cl. G21C 3/54; C23F 11/18; C09K 5/12; C09K 15/02; G21C 19/28; G21C 15/28; G21C 17/022

(52) U.S. Cl. CPC G21C 3/54; C23F 11/185; C09K 5/12; G21C 17/0225; G21C 19/28; G21C 15/28; C09K 15/02

(57) ABSTRACT

A molten halide salt mixture for use in a nuclear fission reactor. The molten halide salt mixture comprises a reactive metal halide salt. The reactive metal halide salt is a halide salt of a reactive metal. The reactive metal has a Pauling electronegativity of at least 1.2, and at least one other halide salt of higher valence than the reactive metal halide salt. The reactive metal salt is at a concentration sufficient to prevent corrosion of metals in contact with the molten halide salt mixture and insufficient to cause deposition of the reactive metal at an operating temperature of the nuclear fission reactor.

### BACKGROUND

Molten salts are known to be highly corrosive to metals because of their ability to dissolve protective oxide layers from the metal. The more chemically reactive species in the metal then dissolve as metal salts in the molten salt.

In the case of molten halide salts, corrosion can be reduced by contacting the salt with a more reactive sacrificial metal. For steels, relevant sacrificial metals are zirconium, titanium or other metals as described in WO 2015/140495. In many cases however this approach is impractical due to migration of the sacrificial metal from one area in contact with the molten salt to another. This can occur by simple dissolution/redeposition or by galvanic transfer. There remains a need to a way to control corrosion where continuous contact of a sacrificial metal with the molten salt is impractical.

### SUMMARY

According to a first aspect, there is provided a molten halide salt mixture for use in a nuclear fission reactor. The molten halide salt mixture comprises a reactive metal halide salt. The reactive metal halide salt is a halide salt of a reactive metal. The reactive metal has a Pauling electronegativity between 1.2 and 1.7, and at least one other halide salt of higher valence than the reactive metal halide salt. The reactive metal salt is at a concentration sufficient to prevent corrosion of metals in contact with the molten halide salt mixture and insufficient to cause deposition of the reactive metal at an operating temperature of the nuclear fission reactor.

According to a further aspect, there is provided a nuclear fission reactor comprising a molten halide salt fissile fuel, wherein the molten halide salt fissile fuel is a molten halide salt according to the first aspect.

According to a further aspect, there is provided a nuclear fission reactor comprising a molten halide salt coolant, wherein the molten halide salt coolant is a molten halide salt according to the first aspect.

According to a further aspect, there is provided a method of reducing corrosion of metals by a molten halide salt mixture. The method comprises including a reactive metal halide salt in the molten halide salt mixture. The reactive metal halide salt is a halide salt of a reactive metal. The reactive metal has a Pauling electronegativity between 1.2 and 1.7, and at least one other halide salt of higher valence than the reactive metal halide salt. The reactive metal salt is at a concentration sufficient to prevent corrosion of metals in contact with the molten halide salt mixture and insufficient to cause deposition of the reactive metal at an operating temperature of the nuclear fission reactor.

Further specific embodiments are defined in claim 2 et seq.

### BRIEF DESCRIPTION OF THE DRAWINGS

FIG. 1 shows an exemplary nuclear fission reactor.

### DESCRIPTION

It has now been discovered that addition of small amounts of low valency halides of reactive metals to molten halide salt mixtures has remarkably high efficacy in preventing corrosion of metals. Without being restricted by theory, it is believed this is due to the combination of the naturally low redox potential of the low valency halide with the extreme stability of the oxides of the metals. The latter results in oxygen from air or water contamination of the molten salt being sequestered in a non reactive form.

Reactive metals which are suitable for use are those with at least two stable halides of different valencies, and with a Pauling electronegativity between 1.2 and 1.7. Metals with an electronegativity above 1.7 will generally not provide an anticorrosive effect, and metals with an electronegativity below 1.2 are likely to cause unwanted redox reactions within the molten salt (e.g. reducing sodium salts to their metal form). For example, zirconium (ZrF₂, ZrF₄), titanium (TiF₂, TiF₄), and vanadium (VF₂, VF₃) would be suitable. The reactive metal salt which is used to prevent corrosion is then the lower valency halide salt of the reactive metal. In particular, the stable monovalent and divalent halide salts of zirconium, titanium, and vanadium are suitable, e.g. ZrF₂, ZrCl, TiF₂, VF₂.

In order to prevent deposition of the pure metal on surfaces in contact with the molten salt mixture, the concentration of the reactive metal halide should be insufficient to cause such deposition at the operating temperature of the molten halide salt mixture. The maximum concentration will depend on the reactive metal salt used, the other metal salts in the molten halide salt mixture, the temperature, and other factors. In general, the maximum concentration will be larger if the reactive metal salt contains the same metal as another salt in the molten salt mixture (e.g. where the higher valency halide salt of the reactive metal is present in the molten salt mixture, such as VF₂ in a molten salt containing VF₅).

For the rest of this disclosure, zirconium difluoride is used as an exemplary reactive metal halide salt. However, it will be appreciated that the embodiments presented can be achieved with other reactive metal halide salts as described above.

The zirconium difluoride can be added to the salt directly, or generated in situ by dissolving small amounts of metallic zirconium in a fluoride containing molten salt. This is particularly useful as an approach where a significant component of the molten salt is zirconium tetrafluoride but can be applied to any molten halide salt mixture.

The zirconium difluoride concentration in the molten salt will fall over time as oxygen or water enters the molten salt, resulting in formation of zirconium oxide and zirconium tetrafluoride.

The zirconium difluoride concentration may be monitored electrochemically and additional zirconium metal or zirconium difluoride added to maintain the zirconium difluoride level.

Alternatively, a solid zirconium metal rod or other structure can be intermittently immersed in the molten salt for a period sufficient to replenish the zirconium difluoride concentration but not long enough to raise the zirconium difluoride concentration to the point where deposition of zirconium on surfaces exposed to the molten salt will occur.

A further alternative is to continuously contact the zirconium metal with a portion of the molten salt which is cooled to a lower temperature than the bulk of the molten salt that contacts the other metal surfaces. As the equilibrium concentration of zirconium difluoride in contact with zirconium metal rises with temperature, this prevents redeposition of the zirconium on surfaces in contact with the molten salt.

A similar approach can be used with chloride or mixed halide salts. With chloride salt systems, zirconium monochloride is the species added. Zirconium monochloride can be prepared by reaction of zirconium tetrachloride with zirconium metal but it will in most cases be convenient to introduce it to the molten salt system by contacting the salt with zirconium metal as described for zirconium difluoride.

Other monovalent or divalent zirconium halide salts may be used to equivalent effect in other salt mixtures.

The range of concentrations for which the zirconium salt will not deposit zirconium metal is dependent on the temperature of the salt—at lower temperatures, the allowable concentration is lower. At typical molten salt temperatures, a range of 0.1% to 2% zirconium halide will be appropriate (and similar ranges are appropriate for titanium and vanadium halides), but the skilled person will readily be able to determine whether a given concentration will cause deposition at the operating temperature of their application for the salt, and whether the concentration will be sufficient to prevent corrosion of metals in contact with the molten salt (i.e. to maintain a low redox state of the molten salt).

Molten halide salt mixtures for use as fissile fuel salts or coolant salts in a nuclear fission reactor could be adapted using the above disclosure to reduce corrosion in such a reactor.

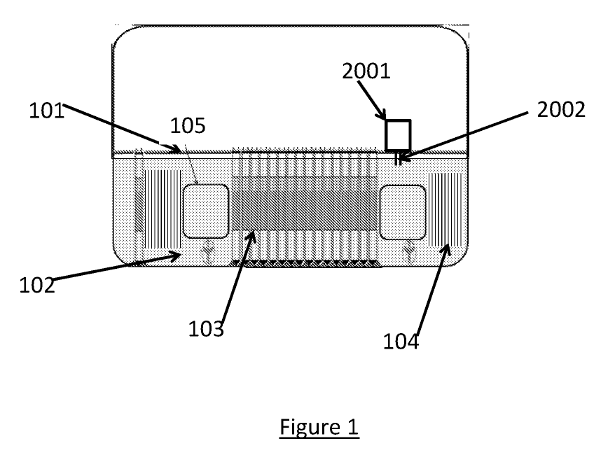

An exemplary reactor where a zirconium halide is used in the coolant salt is shown in FIG. 1. The reactor comprises a tank 101 containing coolant salt 102. Fuel tubes 103 are located within the coolant salt, forming the core of the reactor. Heat exchangers 104 withdraw the heat from the coolant salt, and flow baffles 105 are placed to improve convection of the coolant salt. Deposition of zirconium on any of these components could interfere with the operation of the reactor, e.g. reducing the efficiency of the heat exchanger.

The reactor further comprises a source of zirconium halide 2001, and a sensor 2002. The sensor 2002 is configured to determine a concentration of zirconium halide in the coolant salt 102. If the zirconium halide concentration is below a threshold (determined to keep the concentration of zirconium halide sufficient to reduce corrosion as described above), then additional zirconium halide is added from the source 2001. The source may directly add zirconium halide, or it may add zirconium metal (e.g. by addition of metal pellets which then dissolve, or by temporarily immersing zirconium metal in the molten salt coolant). The amount of zirconium halide added is determined such that the concentration does not rise sufficiently to cause zirconium metal to deposit on components in contact with the coolant salt.

1. A molten halide salt mixture for use in a nuclear fission reactor, the molten halide salt mixture comprising a reactive metal halide salt, wherein the reactive metal halide salt is a halide salt of a reactive metal, the reactive metal having:
a Pauling electronegativity between 1.2 and 1.7, and
at least one other halide salt of higher valence than the reactive metal halide salt and wherein the reactive metal salt is at a concentration sufficient to prevent corrosion of metals in contact with the molten halide salt mixture and insufficient to cause deposition of the reactive metal at an operating temperature of the nuclear fission reactor.

2. A molten halide salt mixture according to claim 1, wherein the reactive metal halide salt is a monovalent or divalent halide salt of titanium, zirconium, or vanadium.

3. A molten halide salt mixture according to claim 2, wherein the reactive metal halide salt is one of:
zirconium monochloride;
zirconium difluoride;
titanium difluoride;
vanadium difuoride.

4. A molten halide salt mixture according to claim 1, wherein the molten salt is for use as one of:
a fissile fuel;
a coolant salt.

5. A molten halide salt mixture according to claim 1, wherein the concentration of reactive metal halide salt is between 0.1% and 2%.

6. A molten halide salt mixture according to claim 1, wherein the molten halide salt mixture further comprises a further halide salt of the reactive metal having a higher valence than the reactive metal halide salt.

7. A nuclear fission reactor comprising a molten halide salt fissile fuel, wherein the molten halide salt fissile fuel is a molten halide salt mixture according to claim 1.

8. A nuclear fission reactor comprising a molten halide salt coolant, wherein the molten halide salt coolant is a molten halide salt mixture according to claim 1.

9. A nuclear fission reactor according to claim 8, and comprising a region of molten salt halide coolant at a lower temperature than other regions of the molten halide salt coolant, and a solid piece of the reactive metal contacting the molten halide salt coolant within that region.

10. A nuclear fission reactor according to claim 8, and comprising a sensor configured to monitor a concentration of the reactive metal halide salt in the molten halide salt coolant, and a reactive metal halide salt source configured to introduce additional reactive metal halide salt to the molten halide salt coolant if the concentration falls below a predefined threshold.

11. A nuclear fission reactor according to claim 10, wherein the reactive metal halide salt source is configured to introduce additional reactive metal halide salt to the molten halide salt coolant by intermittently contacting the molten halide salt coolant with the reactive metal.

12. A method of reducing corrosion of metals by a molten halide salt mixture, the method comprising including a reactive metal halide salt, wherein the reactive metal halide salt is a halide salt of a reactive metal, the reactive metal having:
a Pauling electronegativity between 1.2 and 1.7, and
at least one other halide salt of higher valence than the reactive metal halide salt and wherein the reactive metal salt is at a concentration sufficient to prevent corrosion of metals in contact with the molten halide salt mixture and insufficient to cause deposition of the reactive metal at an operating temperature of the nuclear fission reactor.

13. A method according to claim 12, wherein the reactive metal halide salt is zirconium difluoride.

14. A method according to claim 12, wherein the reactive metal halide salt is zirconium monochloride.

15. A method according to claim 12, wherein introducing the reactive metal halide salt comprises contacting the molten halide salt mixture with the reactive metal in a region at a lower temperature than other regions of the molten halide salt.

16. A method according to claim 12, wherein introducing the reactive metal halide salt comprises intermittently contacting the molten halide salt mixture with the reactive metal.

17. A method according to claim 12, and comprising monitoring a concentration of the reactive metal halide salt in the molten halide salt mixture, and introducing additional reactive metal halide salt to the molten halide salt mixture if the concentration falls below a predetermined threshold.

18. A method according to claim 12, and comprising using the molten halide salt mixture in a nuclear fission reactor as one of:
a fissile fuel;
a coolant salt.

19. A method according to claim 12, wherein the concentration of reactive metal halide salt is between 0.1% and 2%.

20. A method according to claim 12, wherein the molten halide salt mixture further comprises a further halide salt of the reactive metal having a higher valence than the reactive metal halide salt.
